(19) United States
(12) Patent Application Publication
(10) Pub. No.: US 2003/0188018 A1
(43) Pub. Date: Oct. 2, 2003

(54) Technique to accelerate learning rate on linearly sorted lookup tables for high speed switches/routers

(76) Inventors: Miguel A. Guerrero, Fremont, CA (US); Prabhanjan Moleyar, Bangalore (IN)

Correspondence Address: Pillsbury Winthrop LLP, Intellectual Property Group, Suite 2800, 725 South Figueroa Street, Los Angeles, CA, 90017-5406, US

(21) Appl. No.: 10/108,920

(22) Filed: Mar. 28, 2002

(51) Int. Cl. G06F 15/173

(52) U.S. Cl. 709/242; 709/238

(57) ABSTRACT

A lookup table is modified by either the insertion or deletion of an address. A lookup table modification device receives an update instruction and determines a selected memory section of the lookup table and an address to which the update instruction relates. The selected memory section is updated. The lookup table modification device determines succeeding non-selected memory sections to which the update instruction does not relate, and modifies contents of one address in each of the succeeding non-selected memory sections. The lookup table modification device changes the logical origin of each of the succeeding non-selected memory sections.

### BACKGROUND OF THE INVENTION

1. Field of the Invention

This invention relates to the field of data transmission and forwarding in both local area and global networks, e.g., an Internet, and, more specifically, to an apparatus and method to enable accelerated memory table updates in routers and local area network (LAN) switches.

2. Background of the Invention

The importance of high-speed and high-bandwidth transportation of data in both LANs and the Internet is increasing. Current applications, such as Internet video-on-demand or Internet telephony, require large amounts of data to be transferred from a LAN endsystem through the Internet to an endsystem or group of endsystems on other LANs.

LAN switches are evolving to handle the high-bandwidth issues within the LAN. LAN switches receive packets of data and may perform error checks to verify the packet has the necessary format. If the packet does not contain any errors, the LAN switch looks up the packet destination address in its switching table and determines the outgoing port to which the packet is to be transferred. The switching table includes a destination address list along with associated outgoing port interfaces. The LAN switch performs an “exact matching” search, meaning the destination address must exactly match an entry in switching table. The packet is then forwarded to the location associated with the switching table entry.

Internet data is transferred by groups of routers, which are interconnected by communication links. An individual router receives data packets on any of its input links and decides to which of its outgoing links the message may be forwarded based on the packet's encoded destination protocol address. The router makes this determination by comparing the destination protocol address to its router table entries that, similarly to the LAN switch, contain destination protocol addresses and corresponding “next hop” instructions.

Unlike the LAN switch, however, the router performs a “longest prefix matching” search. Routing table entries may not contain the full length of all addresses. The destination protocol address is compared to routing table entries. The router utilizes the forwarding instructions of the entry with which the address has the longest prefix in common. The router changes the packet's destination physical address to the address of the “next hop” information and transmits.

The link speed, data throughput rates, and packet forwarding rates in routers are all major factors in increasing router bandwidth/throughput. Link speed is increased by improvements in cabling in both the LAN and the Internet. Faster switching technology is utilized to move packets from the device's input port to the corresponding output interface at gigabit speeds. Packet forwarding, including the address lookup and routing/switching table update areas, is where the bottleneck exists.

Important criteria in packet forwarding include maximum sustained packet forwarding rate, routing/switching table size, and routing table availability. Routing/switching tables require larger size databases because the number of destination addresses has grown exponentially.

A switching/routing table is a linearly sorted portion of memory in which the addresses to look up may be stored in an ascending or descending order. Presently, the updating of the table with address insertions or deletions is performed by a specialized hardware engine, e.g., a lookup table modification device. For a table of size n in the worst case scenario, when an entry needs to be inserted into the first location, the lookup table modification device needs to ripple down n entries, and requires n reads to memory and n writes to memory. Thus, the total number of operations is 2×n.

FIG. 1 illustrates the operation of a modification device according to the prior art for a lookup table of size 10, e.g., 10 entries. In this case, the total number of operations is 20 (2×10). Therefore, the total number of operations required for updating increases by a factor of two for each new routing/switching table entry. With the exponential growth of destination addresses, the total number of operations required for updating routing/switching tables has also grown exponentially. Thus, utilization of the prior art lookup table modification device will result in a lower packet forwarding rate, because of the increased number of operations spent updating the lookup table. In addition, routing table availability will be a lower value because more time will be spent updating the lookup table, especially with the large size of the switching/routing table.

Accordingly, a need exists to develop a lookup table modification device and method to accelerate the updating of tables to keep pace with the advances in link speed and data throughput, and to assist in eliminating the current bottleneck in the packet forwarding area.

### BRIEF DESCRIPTION OF THE DRAWINGS

FIG. 1 illustrates the operation of a modification device according to the prior art for a lookup table of size 10, e.g., 10 entries;

FIG. 2 illustrates a router/switch according to an embodiment of the present invention;

FIG. 3 illustrates a lookup table modification device according to an embodiment of the present invention;

FIG. 4(a) illustrates a lookup table before insertion of an address according to an embodiment of the present invention;

FIG. 4(b) illustrates the “physical rippling” of a selected memory section by a selection section modification module according to an embodiment of the present invention;

FIG. 4(c) illustrates the “logical rippling” of non-selected succeeding memory sections by a logical rippling module according to an embodiment of the present invention;

FIG. 5 illustrates the “physical rippling” of the selected memory section and the “logical rippling” of the succeeding non-selected memory sections when an address is deleted according to an embodiment of the present invention; and

FIG. 6 illustrates a flowchart for a lookup table modification device according to an embodiment of the present invention.

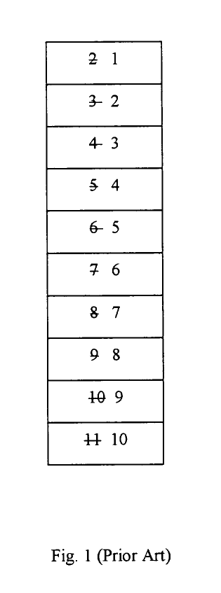

### DETAILED DESCRIPTION

An embodiment of the present invention is directed to a system and method of accelerating the updating of a lookup table located in a packet switching device, such as a router or local area network switch (LAN switch). Data packets are transmitted from a local endsystem to a group of endsystems, or a single remote endsystem, and travel through local area networks and a global network, e.g., an Internet. As a packet travels from the local endsystem to the remote endsystem(s), devices residing on the local area networks and the global network receive the packet, determine the address where the packet needs to be sent, and forward the packet to the address. The lookup table provides instructions for where the packet needs to be sent and the lookup table is updated on a continuous basis in order to keep up with changes in routes (due to hardware additions or deletions or bandwidth bottlenecks) within the local area networks and the Internet.

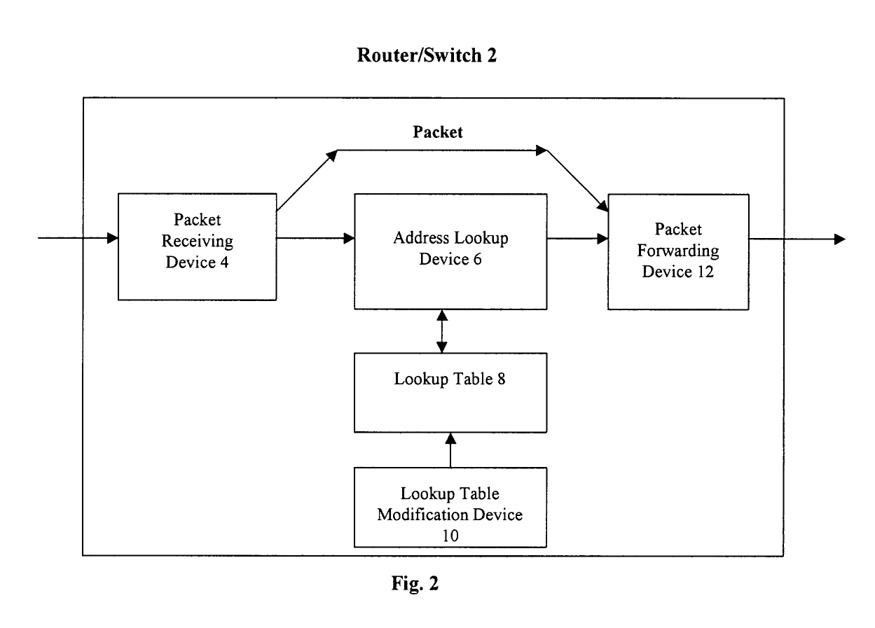

FIG. 2 illustrates a router/switch 2 according to an embodiment of the present invention. The router/switch 2 includes a packet receiving device 4, an address lookup device 6, a lookup table 8, a lookup table modification device 10 and a packet forwarding device 12. The packet receiving device 4 may receive a packet from a transmission line, extract an address from the packet, and output the address to the address lookup device 6. The address lookup device 6 may determine if the address is located in the lookup table 8, output “next hop” information to the packet forwarding device 12 if the address is located in the lookup table 8, and output default next hop information to the packet forwarding device 12 if the address is not located in the lookup table 8.

The lookup table modification device 10 updates the lookup table 8 on a periodic basis based on update instructions from other routers or switches regarding changes in transmission paths on local area networks or the Internet. An embodiment of the present invention accelerates the updating of the lookup table by diving the lookup table into sections, modifying a selected memory section where the address is located, and modifying succeeding non-selected memory sections where the address is not located by updating only one address and changing a logical origin in each of the succeeding non-selected memory sections.

The packet forwarding device 12 receives either the “next hop” information or the default “next hop” information from the address lookup device 6 along with the packet from the packet receiving device 4, and outputs the packet to the address corresponding to the “next hop” information or the default “next hop” information.

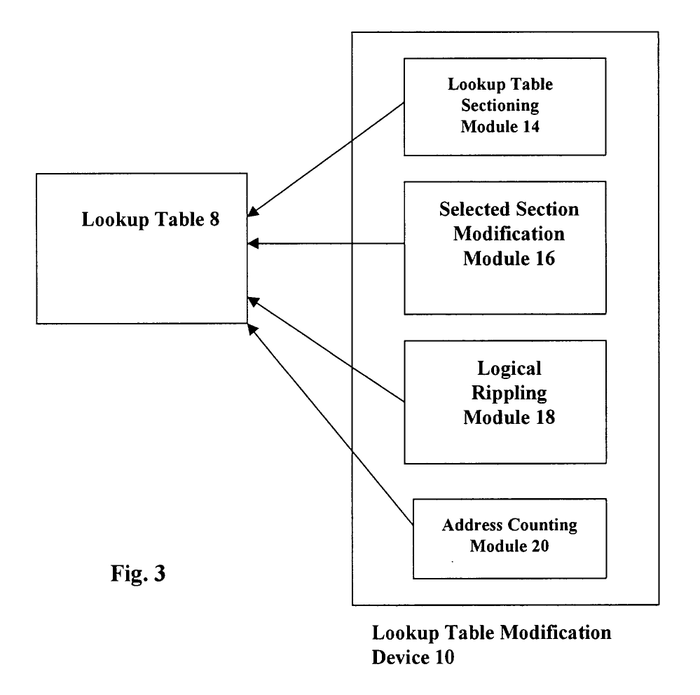

FIG. 3 illustrates a lookup table modification device according to an embodiment of the present invention. The lookup table modification device 10 may include a lookup table sectioning module 14, a selected section modification module 16, a logical rippling module 18, and an address counting module 20. The lookup table 8 may be sorted in an ascending manner. Alternatively, the lookup table 8 may be sorted in a descending manner.

The lookup table modification device 10 may utilize a lookup table sectioning module 14 to divide up the lookup table 8 into memory sections. Alternatively, the lookup table 8 may already be divided into lookup table memory sections before the lookup table modification device 10 attempts to modify an address. If a lookup table sectioning module 14 is utilized, the lookup table sectioning module 14 may divide up a lookup table 8 into sections which are equal in size. Alternatively, the lookup table sectioning module 14 may divide the lookup table 8 into sections which are approximately the same size. Illustratively, if the lookup table has 40 entries, the lookup table sectioning module 14 may divide up the lookup table into four memory sections of ten entries each. Alternatively, the lookup table sectioning module 14 may divide up the lookup table in six memory sections with four of the six memory sections having seven entries and two of the six memory sections having six entries.

The lookup table modification device 10 may receive an update instruction from other routers/switches and instruct the selected section modification module 16 to update a selected lookup table memory section. The selected memory section is the section of the lookup table including the address to which the update instruction applies. The updating of the selected lookup table memory section may be referred to as “physical rippling,” which is described below.

The lookup table modification device 10 may include an address counting module 20. If the address counting module 20 identifies that the lookup table 8 is full, i.e., may contain no more addresses, the address counting module 20 may instruct the lookup table modification device 10 to reject the update instruction if the update instruction involves the addition of an address. Alternatively, the lookup table modification device 10 may accept the update instruction and this may result in an address currently residing in the lookup table 8 being ejected or dropped from the lookup table 8.

The logical rippling module 18 may update a plurality of succeeding non-selected memory sections. The succeeding non-selected memory sections may be the memory sections succeeding the selected memory section in the lookup table 8. The preceding non-selected memory sections may not need to be modified by either the selected section modification module 16 or the logical rippling module 18. The preceding memory sections may be the memory sections preceding the selected memory section in the lookup table 8. If the address is being inserted into a last memory section, e.g., the last memory section in the lookup table, then no “logical rippling” may occur because there are no succeeding non-selected memory sections.

The logical rippling module 18 may modify the contents of a single address in each of the succeeding non-selected memory sections. In addition, the logical rippling module 18 may change the logical origin of each of the non-selected memory sections by either incrementing or decrementing the logical origin. The logical origin of the memory section is an indicator pointing to the lowest value of the addresses residing in the memory section if the lookup table is sorted in an ascending manner.

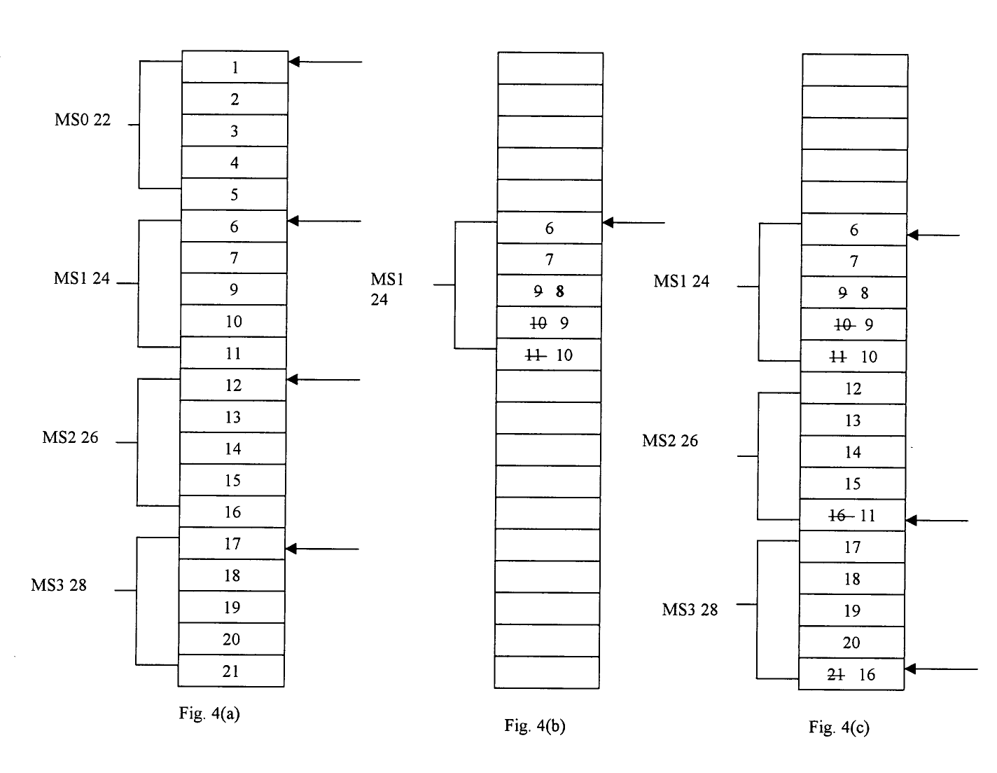

FIG. 4(a) illustrates a lookup table before insertion of an address according to an embodiment of the present invention. The memory table may be numerically sorted in an ascending manner. Illustratively, the memory table is divided into four sections (MS0 22, MS1 24, MS2 26, and MS3 28). The four memory sections (MS0 22, MS1 24, MS2 26, and MS3 28) each include five memory addresses.

In this embodiment of the present invention, a memory address may be added or inserted into any of the memory sections (MS0 22, MS1 24, MS2 26, or MS3 28). In an alternative embodiment of the present invention, a memory address may be deleted from any of the memory sections (MS0 22, MS1 24, MS2 26, or MS3 28). The update instruction may include the memory address and whether or not the address may be inserted or deleted.

In this embodiment of the present invention, as illustrated in FIG. 4(a), where an address is inserted and the address is to be inserted into memory section MS1 24, MS1 24 is the selected memory section. Therefore, MS2 26 and MS3 28 are the succeeding non-selected memory sections. MS0 22 is the preceding non-selected memory section. In the selected memory section MS1 24, address 8 is inserted in between address 7 and address 9. The selected section modification module 16 inserts the address in the selected memory section, e.g. MS1 24, which may require a “physical rippling” of the selected memory section MS1 24 starting with the address after the inserted address, e.g. address 8.

FIG. 4(b) illustrates the “physical rippling” of a selected memory section by the selection section modification module 16 according to an embodiment of the present invention. “Physical rippling” refers to the physical movement of addresses after modification, e.g., insertion or deletion, of an address in a selected memory section. For example, the addition of address 8 to memory section MS1 24 results in the “physical rippling” of MS1 24, as illustrated in FIG. 4(b). Illustratively, “physical rippling” involves the movement of address 9 to the spot in memory section MS1 24 where address 10 previously resided, the movement of address 10 to the spot in memory section MS1 24 where address 11 previously resided, and the movement of address 11 out of memory section MS1 24.

FIG. 4(c) illustrates the “logical rippling” of non-selected succeeding memory sections by the logical rippling module 18 according to an embodiment of the present invention. In an embodiment of the present invention where an address is added to a selected memory section, as illustrated in FIG. 4(c), the logical rippling modules performs “logical rippling” in succeeding non-selected memory sections MS2 26 and MS3 28. Illustratively, address 11 is pushed out of memory section MS1 24 during the “physical rippling” of selected memory section MS1 24 and placed in memory section MS2 26. Address 16 is pushed out of memory section MS2 26 and placed in memory section MS3 28. In an embodiment of the present invention, address 11 is placed in the memory location previously occupied by address 16, as illustrated in FIG. 4(c). The invention may only require one memory read (to take address 16 out of memory section MS2 26) and one memory write (to place address 11 in memory section MS2 26) for each succeeding non-selected memory section. In each succeeding non-selected memory section during the addition of an address to the selected memory section, a last address in each of the succeeding non-selected memory sections may be the location whose contents are modified.

The same process may take place when address 16 is placed in memory section MS3 28 and in each succeeding non-selected memory section except the process may be different when the memory section is a last succeeding non-selected memory section in the lookup table 8. In one embodiment of the present invention, the lookup table modification device may not accept the update instruction command if all locations in each of the memory sections of the lookup table 8 have a value. In an alternative embodiment of the present invention, if the last succeeding non-selected memory section is full, the logical rippling module 18 may “logically ripple” an address out of the last succeeding non-selected memory section. In another alternative embodiment of the present invention, if the last non-selected memory section has an empty address location, the address removed from the previous succeeding non-selected memory section may be placed in the empty address location. This procedure requires only one memory operation because the logical rippling module needs only to perform one memory write, e.g., to add the address into the empty location in the last succeeding non-selected memory section.

The logical origin of MS2 26, as illustrated by the arrows in FIG. 4(c), is decremented by one address to continue to maintain the numerical order of both the memory section and the lookup table. For example, as illustrated in FIGS. 4(a) and 4(c), the logical origin previously pointed to address 12 (see FIG. 4(a)), while after the “logical rippling” the decremented logical origin now points to address 11 (see FIG. 4(c)), which is the lowest value in non-selected succeeding memory section MS2 26. Similarly, the logical origin of non-selected succeeding memory section MS3 28 is decremented to address 16, while it was previously address 17. The preceding memory section, e.g., MS0 22, did not require any modification because the contents of its memory addresses were not changed.

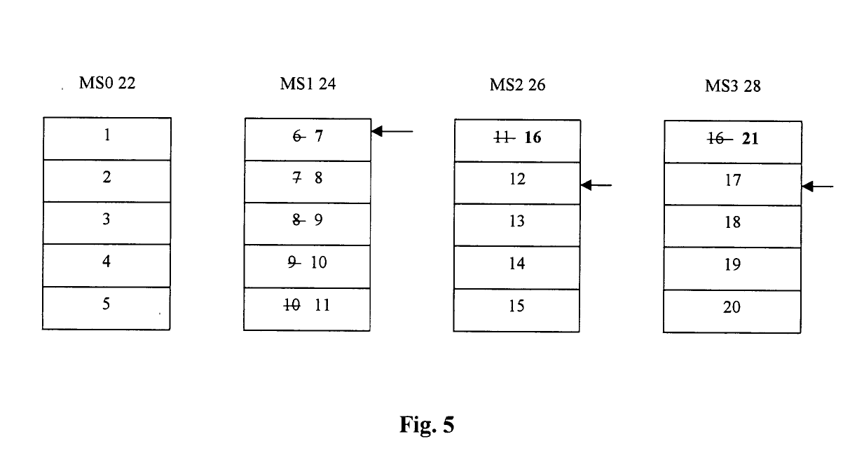

In an embodiment of the present invention where the address may be deleted from the memory section, “physical rippling” may occur in the selected memory section. FIG. 5 illustrates the “physical rippling” of the selected memory section and the “logical rippling” of the succeeding non-selected memory sections when an address is deleted according to an embodiment of the present invention. In the preceding non-selected memory sections in the lookup table 8, no modifications to the lookup table 8 may be required because the preceding memory sections are not changed. In the succeeding non-selected memory sections, “logical rippling” may take place.

For example, as illustrated in FIG. 5 where address 6 was deleted from memory section MS1 24, “physical rippling” may occur. After the deletion of address 6, address 7 occupies the location previously occupied by address 6; address 8 occupies address 7's previous location; address 9 occupies address 8's previous location; address 10 occupies address 9's previous location; and address 11 enters memory section MS1 24 and occupies address 10's previous location.

In the preceding non-selected memory sections, no modifications may occur. Illustratively, memory section MS0 22 does not require any modification.

In the succeeding non-selected memory sections, the logical rippling module 18 may perform a “logical rippling” of the memory section. “Logical rippling” may include the changing of the contents of one of the addresses in the memory section, e.g., pushing one address out and pushing another address in. “Logical rippling” also may include modifying the logical origin of the succeeding non-selected memory sections. In the case of the deletion of an address, the logical origin of the succeeding non-selected memory sections may be incremented by one location.

As illustrated in FIG. 5, the succeeding non-selected memory sections MS2 26 and MS3 28 are “logically rippled” after address 6 is deleted from memory section MS1 24. For example, in memory section MS2 26, address 16, originally from memory section MS3 28, is inserted into memory section MS2 26 in the place where address 11 previously resided. In memory section MS3 28, address 21 is inserted into memory section MS3 28 in the place where address 16 previously resided. The logical origin of succeeding non-selected memory sections MS2 26 and MS3 28, as illustrated by the arrows in FIG. 5, are both incremented by one address or location. The logical origin for the succeeding non-selected memory section MS2 26 is incremented to indicate address 12, when it previously indicated address 11. The logical origin for the succeeding non-selected memory section MS3 is incremented to indicate address 17, which is now the lowest address in memory section MS3 28, when it previously indicated address 16.

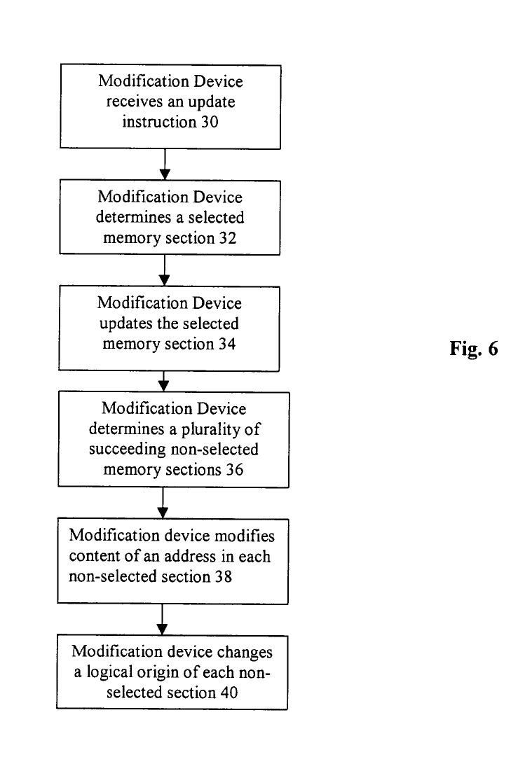

FIG. 6 illustrates a flowchart for a lookup table modification device for an embodiment of the present invention. A lookup table modification device 10 modifies contents of a lookup table 8 when update instructions are received. The lookup table modification device 10 receives 30 an update instruction. The lookup table modification device determines 32 a selected memory section of the lookup table. The lookup table modification device updates 34 the selected memory section. The lookup table modification device 10 determines 36 a plurality of succeeding non-selected memory sections to which the update instruction does not relate. The lookup table modification device 10 modifies 38 content of an address in each of the succeeding non-selected memory sections and changes 40 a logical origin of each of the succeeding non-selected memory sections.

An embodiment of the present invention may also be utilized in any linearly sorted memory that is divided into sections. Illustratively, the memories may include a computer main memory, a memory included on an interface board, or a memory located anywhere in a computing device. The memory may be linearly sorted in an ascending or descending manner.

While the description above refers to particular embodiments of the present invention, it will be understood that many modifications may be made without departing from the spirit thereof The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are intended to be embraced therein.

What is claimed is:

1. A memory modification device in a sorted memory with a plurality of memory sections, comprising:
a selected section modification module to receive an update instruction and to update a selected memory section; and
a logical rippling module to update a plurality of succeeding non-selected memory sections by modifying contents of an address in each of the non-selected memory sections and by changing a logical origin of each of the non-selected memory sections.

2. The memory modification device of claim 1, wherein the update instruction is an addition of an entry to the selected memory section, contents of a last entry in each of the succeeding non-selected memory sections are changed, and the logical origin of each of the succeeding non-selected memory sections is decremented by one entry.

3. The memory modification device of claim 1, wherein the update instruction is a subtraction of an entry from the selected memory section, contents of a first entry in each of the succeeding non-selected memory sections are changed, and the logical origin of each of the succeeding non-selected memory sections is incremented by one entry.

4. A sorted lookup table modification device, comprising:
a selected section modification module to receive an update instruction and to update a selected lookup table memory section; and
a logical rippling module to update a plurality of succeeding non-selected lookup table memory sections by modifying contents of an address in each of the succeeding non-selected lookup table memory sections and by changing a logical origin of each of the succeeding non-selected lookup table sections.

5. The sorted lookup table modification device of claim 4, wherein the update address instruction is an addition of an address to the selected lookup table memory section, contents of a last address in each of the succeeding non-selected lookup table memory sections are changed, and the logical origin of each of the succeeding non-selected lookup table sections is decremented by one address.

6. The sorted lookup table modification device of claim 4, wherein the update address instruction is a deletion of an address to the selected lookup table memory section, contents of a first address in each of the succeeding non-selected lookup table memory sections are changed, and the logical origin of each of the succeeding non-selected lookup table memory sections is incremented by one address.

7. The sorted lookup table modification device of claim 4, further including a lookup table sectioning module to divide a sorted lookup table into a plurality of memory sections before the selected section modification module receives the update instruction.

8. A routing device, comprising:
a packet receiving device to receive a packet from a transmission line;
an address lookup device to determine if a packet address is contained in a sorted lookup table and to provide next hop information for the packet;
a sorted lookup table modification device to modify contents of the lookup table including
a selected section modification module to receive an update instruction and to update a selected lookup table memory section, and
a logical rippling module to update a plurality of succeeding non-selected lookup table memory sections by modifying contents of an address in each of the succeeding non-selected lookup table memory sections and changing a logical origin of each of the succeeding non-selected lookup table sections; and
a packet forwarding device to receive the next hop information for the packet and to transmit the packet to the address corresponding to the next hop information.

9. The routing device of claim 8, wherein the update instruction is an addition of an address to the selected lookup table memory section, contents of a last address in each of the succeeding non-selected lookup table memory sections are changed, and the logical origin of each of the succeeding non-selected lookup table sections is decremented by one address.

10. The routing device of claim 8, wherein the update instruction is a deletion of an address to the selected lookup table memory section, contents of a first address in each of the succeeding non-selected lookup table memory sections are changed, and the logical origin of each of the succeeding non-selected lookup table memory sections is incremented by one address.

11. The routing device of claim 8, further including a lookup table sectioning module to divide the sorted lookup table into a plurality of memory sections before the selected section modification modules receives the update instruction.

12. A local area network (LAN) switching device, comprising:
a packet receiving device to receive a packet from a transmission line;
an address lookup device to determine if a packet address is contained in a sorted lookup table and to provide next hop information for the packet;
a sorted lookup table modification device including
a selected section modification module to receive an update instruction and to update a selected lookup table memory section, and
a logical rippling module to update a plurality of succeeding non-selected lookup table memory sections by modifying contents of an address in each of the succeeding non-selected lookup table memory sections and changing a logical origin of each of the succeeding non-selected lookup table sections; and
a packet forwarding device to receive the next hop information for the packet and to transmit the packet to a forwarding address corresponding to the next hop information.

13. The LAN switching device of claim 12, wherein the update instruction is an addition of an address to the selected lookup table memory section, contents of a last address in each of the succeeding non-selected lookup table memory sections are changed, and the logical origin of each of the succeeding non-selected lookup table sections is decremented by one address.

14. The LAN switching device of claim 12, wherein the update instruction is a deletion of an address to the selected lookup table memory section, contents of a first address in each of the succeeding non-selected lookup table memory sections are changed, and the logical origin of each of the succeeding non-selected lookup table memory sections is incremented by one address.

15. The LAN switching device of claim 12, further including a lookup table sectioning module to divide the sorted lookup table into a plurality of memory sections before the selected section modification module receives the update instruction.

16. A method of modifying lookup table addresses, comprising:
receiving an update instruction;
determining a selected memory section of a sorted lookup table to which the update instruction relates;
updating the selected memory section;
determining succeeding non-selected memory sections to which the update instruction does not relate;
modifying contents of an address in each of the succeeding non-selected memory sections; and
changing a logical origin of each of the succeeding non-selected memory sections.

17. The method of claim 16, wherein the update instruction is an address insertion, a last address in each of the succeeding non-selected memory sections is modified, and the logical origin in each of the succeeding non-selected memory sections is decremented by one address.

18. The method of claim 16, wherein the update instruction in an address deletion, a first address in each of the succeeding non-selected memory sections is modified, and the logical origin in each of the succeeding non-selected memory sections is incremented by one address.

19. The method of claim 16, further including sectioning, by a lookup table sectioning module, of the sorted lookup table into a plurality of memory sections before updating the selected memory section, modifying the non-selected memory sections or changing the logical origin of the non-selected memory sections.

20. The method of claim 17, further including determining, by an address counting module, the sorted lookup table is full and not receiving the update instruction nor updating the selected memory section.

21. A program code storage device, comprising:
a machine-readable storage medium; and
machine-readable program code, stored on the machine readable storage medium, the machine-readable program code having instructions to
receive an update instruction from an update device,
determine a selected memory section to which the update instruction relates,
update the selected memory section,
determine succeeding non-selected memory sections to which the update instruction does not relate,
modify contents of an address in each of the succeeding non-selected memory sections, and
change a logical origin of each of the succeeding non-selected memory sections.

22. The program code storage device of claim 21, wherein the address instruction is an address insertion, a last address in each of the succeeding non-selected memory sections is modified, and the logical origin in each of the succeeding non-selected memory sections is decremented by one address.

23. The program code storage device of claim 21, wherein the update instruction is an address deletion, a first address in each of the succeeding non-selected memory sections is modified, and the logical origin in each of the succeeding non-selected memory sections is incremented by one address.

24. The program code storage device of claim 22, wherein an address counting module determines that a sorted lookup table is full and does not receive the update instruction nor update the selected memory section.
